(19) United States
(12) Patent Application Publication
(10) Pub. No.: US 2024/0035978 A1
(43) Pub. Date: Feb. 1, 2024

(54) MULTI-SPOT CONFOCAL IMAGING SYSTEM WITH SPECTRAL MULTIPLEXING

(71) Applicant: FEI DEUTSCHLAND GMBH, Dreieich (DE)

(72) Inventors: Rainer DAUM, Gräfelfing (DE); Xaver VOEGELE, Gräfelfing (DE)

(21) Appl. No.: 18/356,979

(22) Filed: Jul. 21, 2023

Related U.S. Application Data
(60) Provisional application No. 63/393,153, filed on Jul. 28, 2022.

(51) Int. Cl. G01N 21/64; G02B 21/16; G02B 21/00; G02B 21/24

(52) U.S. Cl. CPC G01N 21/6458; G02B 21/16; G02B 21/0032; G02B 21/0036; G02B 21/0076; G02B 21/24; G01N 2201/08; G01N 2201/06113; G01N 2201/105

(57) ABSTRACT

Disclosed are confocal microscope systems capable of spectral multiplexing. The systems beneficially provide multiple excitation spots on a sample plane simultaneously, and each spot can provide a different wavelength of excitation light. Scanning the excitation spots across a sample can therefore provide multispectral fluorescence imaging at a faster rate than through the sequential process of conventional laser scanning confocal microscopes. A method of generating a distribution from multiplexed spectral fluorescence data is also disclosed.

### CROSS REFERENCE TO RELATED APPLICATION

This application claims the benefit of U.S. Provisional Application No. 63/393,153, filed Jul. 28, 2022, entitled, “MULTI-SPOT CONFOCAL IMAGING SYSTEM WITH SPECTRAL MULTIPLEXING,” which is incorporated by reference herein in its entirety.

### BACKGROUND

### Technical Field

This disclosure relates to confocal microscopy systems, and in particular to confocal laser scanning microscopy systems configured to provide spectral multiplexing by generating multiple spots of different wavelength simultaneously on a sample plane.

### Related Technology

Confocal microscopy is an imaging technique that utilizes spatial “pinholes” to block out-of-focus light to generate images with higher resolution and contrast relative to conventional microscopy techniques. In conventional fluorescence microscopy, the entire sample is typically exposed to light from the light source. All portions of the sample can therefore fluoresce at the same time, and as a result the microscope's light detector will capture unfocused background fluorescence in addition to the fluorescence from the specific region of focus. In contrast, a confocal microscope utilizes pinholes to focus excitation light on a narrow section and depth of the sample and to eliminate the background, out-of-focus portions of the sample. As a result, only fluorescence emission light close to the focal plane is detected. Because much of the fluorescence is blocked by the pinholes, the signal intensity in confocal microscopy is relatively low. However, confocal microscopes can generate images with higher optical resolution as compared to conventional microscopes.

Spinning disk (also known as Nipkow disk) confocal microscopes position the pinholes on a disk. By spinning the disk, the excitation spots are scanned across the sample. Laser scanning confocal microscopy is another application that utilizes a set of minors to scan a laser across a sample and “descan” the image across a fixed pinhole and detector. However, such microscopes have limitations. For example, conventional laser scanning confocal microscopes are relatively slow (e.g., compared to spinning disk confocal microscopes), and are typically limited to a single excitation spot.

Accordingly, there is an ongoing need for improvements to the field of confocal microscopy, including an ongoing need to improve laser scanning confocal microscope systems.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 is a schematic view of an example confocal microscope system configured to provide spectral multiplexing;

FIGS. 2A and 2B are detailed views, in different example configurations, of the excitation light assembly, excitation port, scan head, emission port, and detector assembly of the confocal microscope system of FIG. 1;

FIG. 3 is an example fiber bundle showing a connector configured to attach the fiber bundle to the excitation port and/or emission port;

FIG. 4 shows cross-sectional views of the excitation connector and emission connector, illustrating an example arrangement of fibers within the respective connectors;

FIGS. 5A-5C illustrate alternative fiber arrangements within the connectors;

FIG. 6 illustrates an alternative configuration in which a single port is configured to function as both the excitation port and the emission port, and where both excitation fibers and emission fibers are included in the same connector;

FIGS. 7A and 7B illustrate alternative fiber arrangements within the combined excitation/emission connector of FIG. 6;

FIG. 8 is an example detector assembly including multiple detector modules, where each detector module is a bank of multiple photomultiplier tubes (PMTs);

FIGS. 9A and 9B show an example of a detector assembly. FIG. 9A illustrates a detector assembly including multiple detector modules, where each detector module is a spectrometer; FIG. 9b illustrates a detector assembly including just one spectrometer for multiple emission fibers.

FIG. 10 is a schematic showing potential cross talk between spatially separated excitation spots with different excitation light wavelengths, the schematic showing that light projected onto one spot can scatter and be detected as coming from one or more other spots;

FIG. 11 is a graphical representation showing optical filtering, using one or more notch filters, to minimize or remove scattered light; and

FIG. 12 is a graphical representation showing frequency modulation without notch filters and showing that more of the signal is maintained relative to when notch filters are used; and

FIG. 13 illustrates an exemplary method of multiplexed spectral fluorescence imaging.

### DETAILED DESCRIPTION

### Overview of Systems for Spectral Multiplexing

As discussed above, conventional laser scanning confocal microscopes utilize a single excitation spot and cannot effectively perform multispectral imaging. With a conventional laser scanning confocal microscope, if multiple excitation wavelengths are used at the same time, the resulting emission spectra will overlap, requiring complex unmixing algorithms to separate the individual emission spectra. Moreover, the use of multiple lasers at the same time at the same spot increases the risk of detrimental photobleaching of the target fluorophores. On the other hand, if different wavelengths of excitation light are applied to the excitation spot sequentially, the overall imaging time is increased.

Some laser scanning confocal microscopes have been designed to provide multiple excitation spots at once for the purpose of decreasing imaging time. While increasing the number of excitation spots can decrease imaging time, such microscopes are incapable of controlling the excitation wavelength at each spot independently. This means that where multispectral imaging using excitation light of different wavelengths is desired, the microscope still must cycle through the desired excitation wavelengths sequentially.

Embodiments described herein address one or more of the limitations of the prior art by providing a confocal microscope system capable of “spectral multiplexing.” The embodiments described herein beneficially provide multiple excitation spots on a sample plane simultaneously, and each spot can provide a different wavelength of excitation light. Scanning the excitation spots across a sample can therefore provide multispectral fluorescence imaging at a faster rate than through the sequential process of conventional laser scanning confocal microscopes.

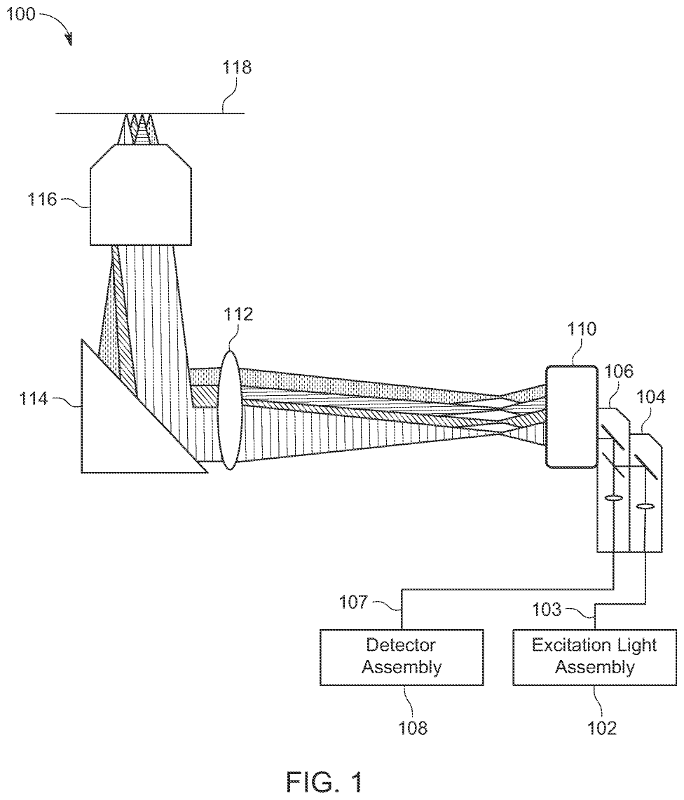

FIG. 1 illustrates a confocal microscope system 100 configured to provide spectral multiplexing. The illustrated system 100 includes an excitation light assembly 102 coupled to an excitation port 104 by way of an excitation fiber bundle 103. The excitation light assembly 102 is configured to provide excitation light at a plurality of different wavelengths (e.g., using a plurality of different laser sources). The excitation fiber bundle 103 includes a plurality of optical excitation fibers each configured to transmit a separate beam of excitation light from the excitation light assembly 102 to an excitation port 104 and then to a scan head 110. An emission port 106, emission fiber bundle 107, and detector assembly 108 receive and detect the resulting fluorescence emission signal. The optical excitation and emission fibers thus function as the “pinholes” of the confocal microscope system 100.

In some embodiments, the excitation light assembly 102 comprises multiple laser sources. Each laser source may be configured to provide excitation light at a different wavelength. In other embodiments, two or more laser sources may provide excitation light at the same wavelength, with at least one other laser source providing excitation light at a different wavelength.

In some embodiments, excitation light of at least two different wavelengths is transmitted by the excitation fiber bundle 103. For example, in some embodiments, each excitation fiber of the excitation fiber bundle 103 transmits a different wavelength of excitation light. In other embodiments, two or more excitation fibers may transmit excitation light of the same wavelength, with at least one other excitation fiber transmitting excitation light of a different wavelength. The excitation fibers may be single-mode fibers configured to transmit a particular excitation light wavelength. For example, each excitation fiber may be configured to transmit the wavelength of the laser source to which the excitation fiber is coupled. Single-mode fibers may have a diameter (e.g., a “mode field diameter”) of about 1 μm to about 10 μm, or about 2 μm to about 5 μm.

In the illustrated embodiment, the excitation port 104 optically connects the excitation fiber bundle 103 (and thus the excitation light assembly 102) to a scan head 110. The scan head 110 may include one or more adjustable minors to enable scanning of the multiple spots of excitation light onto the sample plane 118. For example, the scan head may be configured to scan the multiple spots onto the sample plane according to a two-dimensional raster or other desired scanning pattern. Suitable scan heads are known in the art. In a presently preferred embodiment, the scan head 110 includes one or more features of the deflection device described in U.S. Pat. No. 6,433,908, which is incorporated herein by this reference in its entirety.

The scan head 110 is configured to direct the excitation light onto a sample plane 118 via an optical assembly. In the illustrated embodiment, the optical assembly includes a first lens 112, a reflective surface 114, and a second lens 116. Other embodiments may include different optical assemblies with omitted, additional, or alternative optical components, as known in the art, for transmitting excitation light from the scan head 110 to the sample plane 118. In an embodiment, first lens 112 may be a tube lens. In another embodiment, the second lens may be an objective lens. In an alternate embodiment, reflective surface 114 may be a mirror.

The illustrated system 100 is thus configured to transmit the separate beams of excitation light to multiple, spatially separated spots on the sample plane simultaneously. Each excitation fiber corresponds to a separate spot on the sample plane 118 to which the scan head 110 directs the respective wavelength of excitation light.

The illustrated system 100 also includes an emission port 106 configured to receive emission light from the spots of the sample plane 118, via the optical assembly, and to transmit the received emission light to a detector assembly 108 by way of an emission fiber bundle 107. The emission fiber bundle 107 includes a plurality of emission fibers. Each emission fiber (or a subset of fibers) corresponds to an excitation fiber such that each emission fiber receives emission light resulting from the excitation light of a corresponding excitation fiber. The emission fibers may be multi-mode fibers with a core diameter of about 20 μm to about 80 μm, or about 30 μm to about 70 μm, or about 40 μm to about 60 μm, such as about 50 μm, for example. Various example configurations of excitation fibers and emission fibers, and arrangements matching excitation fibers to one or more emission fibers, are described in more detail below.

In some embodiments, the detector assembly 108 includes multiple detector modules, each configured to provide one or more detection channels. For example, in some embodiments, the detector modules function as “detector banks” that include multiple light detectors/sensors and thus can detect multiple channels or bands of the emitted fluorescence spectrum. Some embodiments may therefore include multiple detector modules that themselves include multiple detectors/sensors. In general, any detector assembly capable of measuring received emission light and sufficiently distinguishing the emission light resulting from the different excitation wavelengths may be utilized. Various preferred detector modules are described in more detail later in this disclosure.

The confocal microscope system 100 may also include other standard components of a confocal microscope, including, for example, a sample stage, microscope frame, and the like.

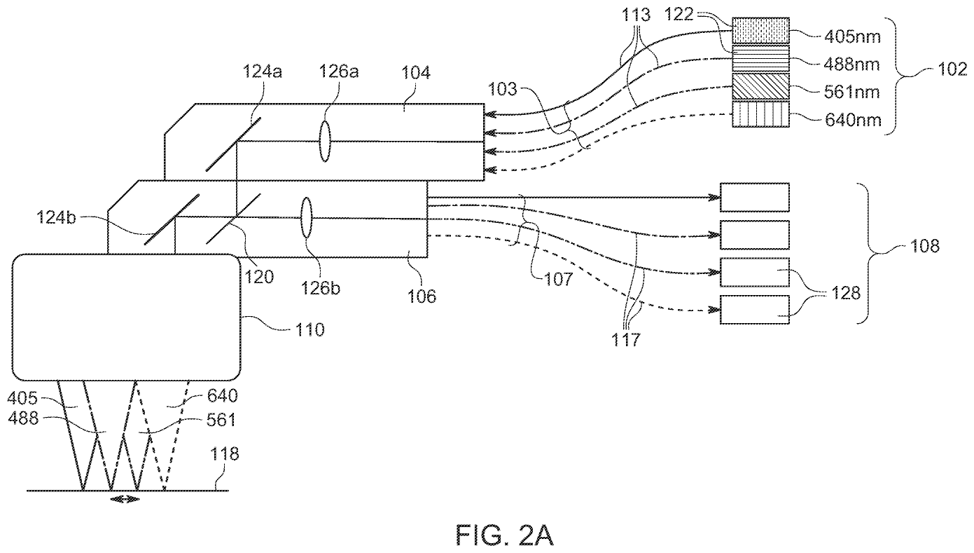

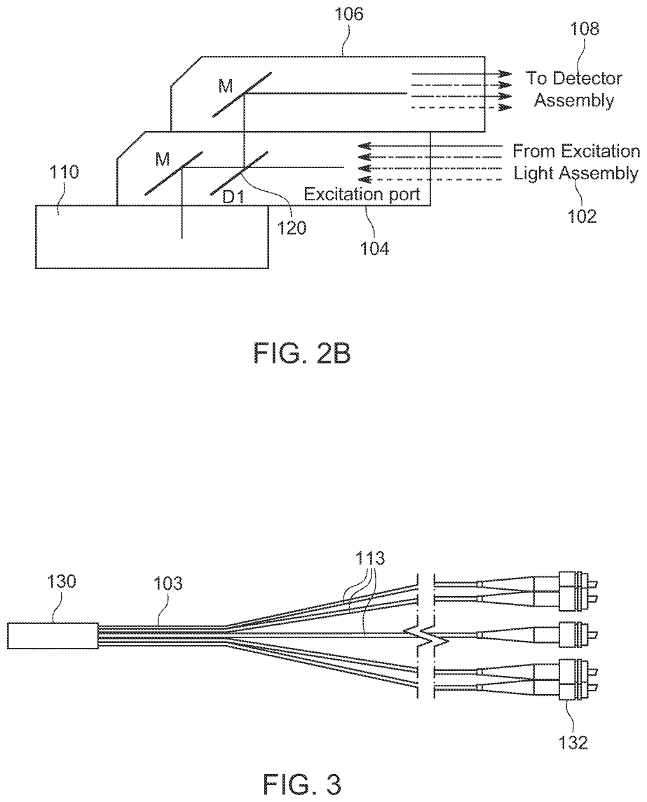

FIG. 2A is a more detailed view of the excitation light assembly 102, excitation port 104, scan head 110, emission port 106, and detector assembly 108 of the confocal microscope system 100. In this view, the components of the optical assembly are removed to better show the other components of the system 100. It will be understood, however, that the description related to FIGS. 2A and 2B (and other embodiments described herein) is also applicable to embodiments that include one or more components of the optical assembly (e.g., tube lens 112, a minor 114, and objective lens 116).

The excitation light assembly 102 of the illustrated embodiment includes a set of laser sources 122 each configured to provide a different wavelength of excitation light. The illustrated laser sources 122 are configured to provide excitation light at 405 nm, 488 nm, 561 nm, and 640 nm. Additional or alternative wavelengths may be utilized in other embodiments according, for example, to user preference and/or application needs.

Further, while the illustrated embodiment includes four different laser sources 122 at four different wavelengths of excitation light, other embodiments may include fewer or more wavelengths of excitation light. For example, the excitation light assembly 102 may be configured to provide at least 2, at least 3, at least 4, at least 5, at least 6, at least 7, at least 8, or at least 9 different wavelengths of excitation light. Some embodiments may be configured to provide greater than 9 different wavelengths of light. The number of different laser sources/wavelengths is only limited by the practicalities of using additional fibers and the size constraints of the corresponding scan head 110 (e.g., size constraints of the mirrors used in the scan head 110).

Each excitation fiber 113 of the excitation fiber bundle 103 is coupled to the excitation port 104. This may be accomplished via a connector configured to orient the excitation fibers relative to one another, as described in more detail below. The excitation port 104 may include one or more optical components for transmitting the excitation light to the scan head 110. Such optical components may include, for example, a condenser 126a and a minor 124a.

In the illustrated embodiment, the excitation light passes from the excitation port 104 to a portion of the emission port 106. The emission port 106 includes a beam splitter 120 configured to reflect at least a portion of the excitation light to the scan head 110 (e.g., via minor 124b). The beam splitter 120 may include multi-band dichroic elements. Preferably, however, the beam splitter 120 omits multi-band dichroic elements to avoid dark regions in the emission signal at the corresponding excitation bands.

As discussed above, the scan head 110 functions to transmit the excitation light to the sample plane 118. Resulting emission light from each spot on the sample plane 118 is transmitted through the scan head 110 and into the emission port 106. A portion of the emission light then passes through the beam splitter 120, through condenser 126b, and then into the emission fibers 117 of the emission fiber bundle 107. As with the excitation fiber bundle 103, the emission fiber bundle 107 typically includes a connector to orient the individual emission fibers for receiving corresponding emission beams from the emission port 106. Moreover, minor 124a (and/or minor 124b) may be configured as an adjustable mirror that can be adjusted to align the excitation spots generated by the excitation light with the resulting emission spots in the sample plane 118.

The emission fibers are coupled to detector modules 128 of the detector assembly 108. For example, as shown, each emission fiber 117 may be coupled to a separate detector module 128. Each detector module 128 includes one or more detection channels. That is, a detector module 128 may be configured to detect a single emission band (e.g., the wavelength of expected emission light), or more preferably, multiple emission bands. In some embodiments, for example, the detector module 128 is configured to detect at least 2, at least 3, at least 4, at least 5, at least 6, at least 7, at least 8, at least 9, at least 10, at least 11, at least 12, at least 13, at least 14, or at least 15 different detection channels.

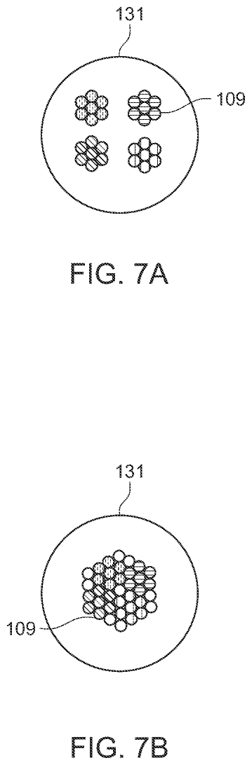

In some embodiments, each detector module 128 corresponds to a specific laser source 122. For example, for each excitation fiber 113, the system 100 includes a corresponding emission fiber 117 (or group of associated emission fibers; see FIGS. 6-7B) configured to receive the emission light resulting from the excitation fiber 113. This emission fiber 117 (or group of associated emission fibers) is coupled to a specific detector module 128.

In FIG. 2A, the excitation port 104 directs excitation light into the emission port 106, where it is partially reflected by the beam splitter 120 toward the scan head 110. Emission light passes into the emission port 106, where it is transmitted through the beam splitter 120 toward the detector assembly 108. In the configuration of FIG. 2A, the beam splitter 120 is preferably greater in transmission than reflectance to allow the larger portion of the emission signal to pass through the beam splitter 120 toward the detector assembly 108.

In the configuration of FIG. 2A, the beam splitter 120 may have a reflectance to transmission ratio (R:T) of about 5:95 to about 20:80, such as about 10:90 or any other R:T ratio therebetween. R:T ratios within the foregoing ranges have been found to beneficially balance the competing demands of supplying sufficient excitation light to the sample while also allowing for a sufficient portion of the emission light to pass through the beam splitter 120 and toward the components of the detector assembly 108.

FIG. 2B is another view, showing a somewhat different configuration, of the excitation port 104, scan head 110, and emission port 106 of the confocal microscope system 100. In FIG. 2B, in contrast to the configuration of FIG. 2A, the beam splitter 120 is positioned within the excitation port 104. Excitation light is partially transmitted by the beam splitter 120 toward the scan head 110. Emission light passes from the scan head 110 into the excitation port 104, where it is partially reflected by the beam splitter 120 into the emission port 106 to be transmitted to the detector assembly 108. In the configuration of FIG. 2B, the beam splitter 120 is preferably greater in reflectance than transmission so that the larger portion of the emission signal is reflected toward the detector assembly 108.

In the configuration of FIG. 2B, the beam splitter 120 may have an R:T ratio of about to about 95:5, such as about 90:10 or any other R:T ratio therebetween.

In some embodiments, the excitation port 104 and/or emission port 106 are configured as modular ports capable of being selectively integrated with a pre-existing confocal microscope system. For example, a modular port may include a scan head attachment site for connecting the modular port to the scan head 110, a fiber bundle attachment site for connecting the modular port to an optical fiber bundle 103 or 107, and an interior optical assembly that forms an optical path for transmission of excitation light from a connected optical fiber bundle toward the scan head attachment site (when configured as an excitation port 104) or for transmission of emission light from a connected scan head 110 toward the fiber bundle attachment site (when configured as an emission port 106).

The modular port may include the beam splitter 120. The modular port may include a secondary port attachment site for connecting a secondary port to the modular port. For example, when the modular port is configured as an excitation port 104, the secondary port can be an emission port 106, and when the modular port is configured as an emission port 106, the secondary port can be an excitation port 104. The secondary port attachment site is substantially aligned with the beam splitter 120 such that the beam splitter 120 can reflect light received from a connected scan head 110 into the secondary port (when the modular port is configured as an excitation port 104), or such that the beam splitter 120 can reflect light received from the secondary port toward a connected scan head 110 (when the modular port is configured as an emission port 106).

FIG. 3 is an example configuration of the excitation fiber bundle 103. The same or similar configuration may be utilized for the emission fiber bundle 107. As shown, the excitation fibers 113 of the excitation fiber bundle 103 terminate at the connector 130. The connector 130 is configured to attach the fibers 113 to the excitation port 104 (or the emission port 106 in the case of the emission fiber bundle 107). The illustrated fiber bundle 103 also includes a set of secondary connectors 132 for connecting each separate fiber 113 to a corresponding laser source (or to a corresponding detector module in the case of the emission fibers).

### Example Optical Fiber Arrangements

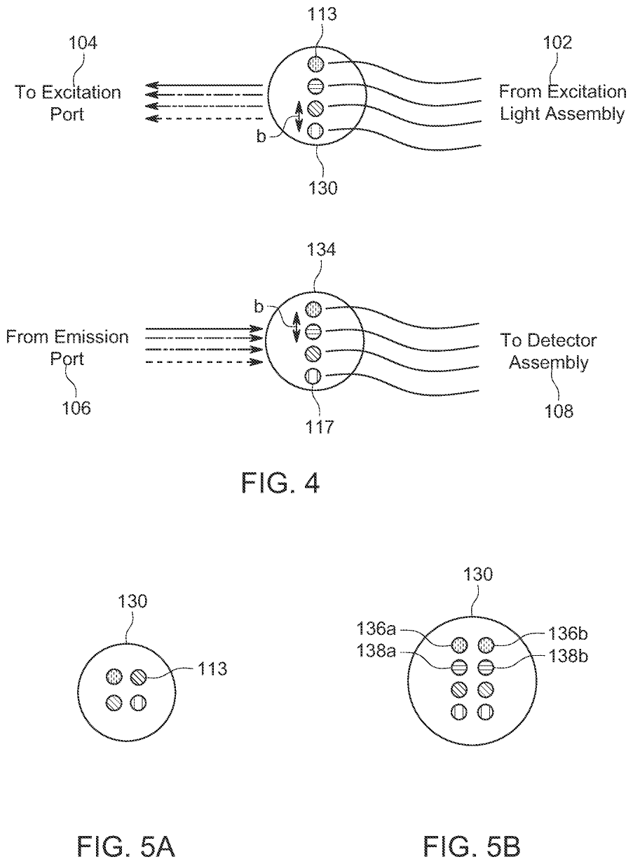

FIG. 4 shows cross-sectional views of the excitation connector 130 and an emission connector 134, illustrating an example arrangement of fibers within the respective connectors. In this example, the excitation fibers 113 of the excitation fiber bundle 103 are aligned in a linear arrangement. The emission fibers 117 of the emission fiber bundle 107 are likewise aligned within the emission connector 134 in a linear arrangement that corresponds to the linear arrangement of the excitation fiber connector 130.

As shown by the distance “b” between fibers, each excitation fiber 113 may be substantially equidistantly spaced within the connector 130 such that the corresponding spots transmitted to the sample plane are substantially equidistantly spaced. Likewise, each emission fiber 117 may be substantially equidistantly spaced within the connector 134. In other embodiments, the fibers 113, 117 need not be equidistantly spaced from one another within the connector 130.

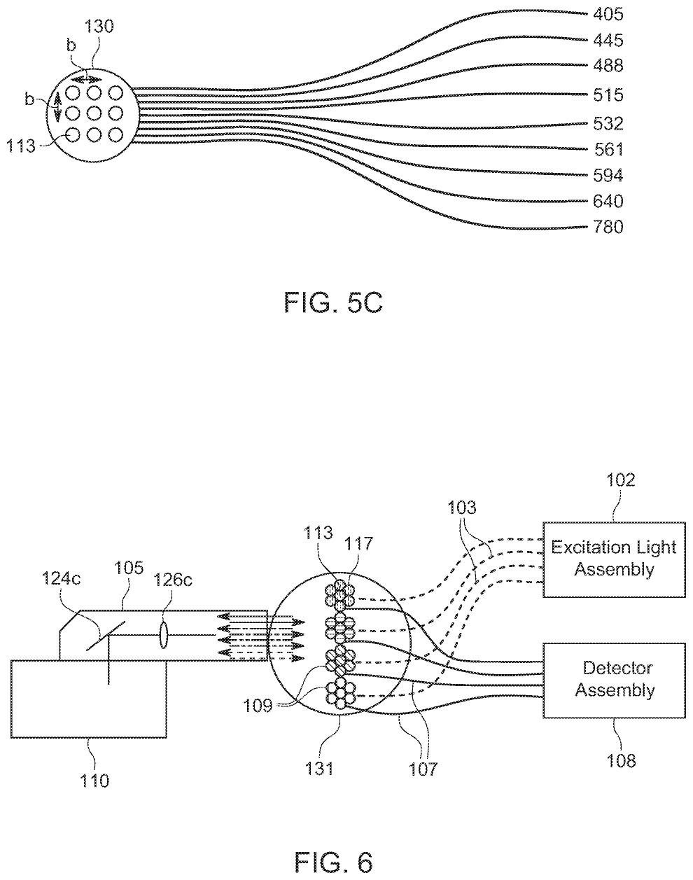

Although the examples of FIG. 4 show the fibers arranged in a linear fashion within the connectors 103, and 134, other embodiments may arrange the fibers differently, such as in a circular, polygonal, or grid pattern. FIGS. 5A-5C illustrate alternative fiber arrangements within the connectors. FIG. 5A, for example, is an embodiment where the excitation fibers 113 are arranged within the connector 130 in a two-dimensional arrangement rather than a linear arrangement. The corresponding emission fibers 117 are similarly arranged in the emission connector 134. As an example, arranging fibers in a two-dimensional pattern such as a grid, as opposed to a one-dimensional linear pattern, can enable more efficient placement of fibers within the connector and/or can enable the use of a greater number of fibers for a given connector size. This in turn enables the formation of a greater number of excitation spots on the sample and provides increased scanning efficiencies. In addition, it may be beneficial to arrange the fibers as close as possible to the optical axis at the center of the connector to minimize aberrations and vignetting. For example, rays may enter the fibers at the end of a linear pattern under a relatively large angle and many will miss the optics. On the other hand, linear arrangements may be less difficult to align and may be preferred in applications where time efficiencies are less important.

FIG. 5B is an example where the fibers are arranged within the connector 130 in a linear arrangement, but each fiber is duplicated. For example, as shown, disposed within the connector 130 is a first fiber 136a of a first wavelength, and a second fiber 136b of the same first wavelength. The connector 130 also includes a first fiber 138a of a second wavelength and a second fiber 138b of the same second wavelength, and so on for as many wavelengths as are utilized (four in this example). The corresponding emission connector 134 may include a similar, corresponding arrangement of fibers. This type of arrangement provides both “spatial multiplexing” (multiple instances of the same wavelength) and “spectral multiplexing” (multiple different wavelengths).

In embodiments including multiple instances of the same wavelength, such as shown in FIG. 5B, each instance may be provided by a separate laser source. Alternatively, two or more instances may be provided by a single laser source where the beam is split to provide the two or more corresponding fibers with the same wavelength.

FIG. 5C shows an embodiment where the excitation fibers 113 are disposed within the connector 130 in a two-dimensional arrangement, similar to the embodiment of FIG. 5A. However, this embodiment includes nine different fibers, each configured to carry a different wavelength of excitation light. The examples shown here include 405 nm, 445 nm, 488 nm, 515 nm, 532 nm, 561 nm, 594 nm, 640 nm, and 780 nm. Additional or alternative wavelengths may be used in other embodiments. Moreover, as discussed above, the excitation fibers and/or excitation light wavelengths may be included in any number so long as the physical components of the system (e.g., fibers, connectors, and scan head 110) are maintained within practical size and functionality limits.

FIG. 6 illustrates an alternative embodiment in which a single port 105 is configured to function as both the excitation port and the emission port (referred to herein as an excitation/emission port 105), and where both excitation fibers 113 and emission fibers 117 are included in the same connector 131 (referred to herein as an excitation/emission connector 131). FIG. 6 shows the connector 131 in a cross-sectional view to illustrate the relative orientations of the excitation fibers 113 and emission fibers 117. The embodiment of FIG. 6 may otherwise be similar to the other embodiments described herein, and thus the features of the embodiment of FIG. 6 may be combined with other features described herein, including with the components of the optical assembly as shown in FIG. 1 and/or with features of FIGS. 2A-5C, except where differences are specified.

In use, excitation light is transmitted from the excitation light assembly 102, through the excitation fibers 113, through the excitation/emission port 105, to the scan head 110, and then to the sample plane (e.g., via a suitable optical assembly such as shown in FIG. 1) to generate multiple spots each corresponding to one of the excitation fibers 113. Emission light from the spots is transmitted back through the excitation/emission port 105, to the emission fibers 117, and then to the detector assembly 108. Because in this configuration the excitation and emission light travel substantially similar paths, the excitation/emission port 105 does not necessarily require a beam splitter. In the illustrated embodiment, the excitation/emission port 105 includes a mirror 124c and condenser 126c.

As shown, the connector 131 orients the optical fibers so that each excitation fiber 113 is associated with one or more emission fibers 117 in a fiber group 109. In presently preferred embodiments, each fiber group 109 includes multiple emission fibers 117 arranged to substantially surround the excitation fiber 113. The illustrated embodiment shows six emission fibers 117 for each excitation fiber 113. Other embodiments may include fewer or more emission fibers 117 for each excitation fiber 113. In some embodiments, each fiber group 109 may include 2, 3, 4, 5, 6, 7, 8, 9, 10, 11, or 12 emission fibers 117 for each excitation fiber 113, for example. The ratio of emission fibers 117 to excitation fibers 113 per fiber group 109 may vary depending on particular application needs and/or the relative sizes of the excitation fibers 113 and emission fibers 117.

The configuration shown in FIG. 6 beneficially combines the functions of the excitation port and emission port into a single excitation/emission port 105. The configuration shown in FIG. 6 also beneficially eliminates the need for fine alignment between separate excitation and emission fiber bundles. On the other hand, the illustrated configuration may have reduced detection efficiency relative to the other embodiments described herein relative to those embodiments with separate excitation and emission ports and separate fiber bundles and connectors because emission signals aligned with the excitation fiber 113 are not detected. Thus, embodiments including separate excitation and emission ports (and separate excitation and emission fiber bundles and connectors) may be particularly beneficial where relatively higher detection efficiency is desired, whereas embodiments with a combined excitation/emission port (and combined fiber bundles and connectors) may be particularly beneficial where higher detection efficiencies are not required and can be traded for a relatively simpler optical setup.

FIGS. 7A and 7B illustrate alternative arrangements of the fiber groups 109 within the excitation/emission connector 131. FIG. 7A illustrates a two-dimensional arrangement of fiber groups 109. FIG. 7B illustrates a clustered arrangement of fiber groups 109. As shown in FIG. 7B, the fiber groups 109 may be adjacent one another. Other arrangements of fiber groups 109 are also possible, including circular, polygonal, and alternative grid patterns, for example. In some embodiments, each fiber group 109 includes a different excitation fiber configured to carry light of a different wavelength. In some embodiments, two or more fiber groups 109 include the same excitation fiber and carry light of the same wavelength. For example, some embodiments may be similar to the arrangement shown in FIG. 5B but with fiber groups 109 rather than individual fibers.

The different types of fiber arrangements illustrated herein may have different benefits depending on application. For example, an arrangement where the fiber groups 109 are generally clustered and/or adjacent to each other, such as shown in FIG. 7B, may be preferred in applications where more efficient use of available space within the connector 131 is desired. Such an arrangement may additionally provide manufacturing benefits. For example, it may be easier, from a manufacturing perspective, to position all of the individual fibers together into one relatively large bundle as opposed to separately positioning the multiple fiber groups 109 within the connector 131. In addition, as discussed above with respect to FIGS. 4 to 5B, more compact arrangements may minimize aberrations and vignetting. On the other hand, the relatively closer positioning of the fiber groups 109 of FIG. 7B may enhance the amount of stray excitation light entering non-corresponding emission fibers (e.g., of a neighboring fiber group 109). Thus, in applications where stray light effects are of more concern, an arrangement where the fiber groups 109 are generally spaced apart from one another, such as in FIG. 7A, may be preferred.

### Example Detection Assemblies

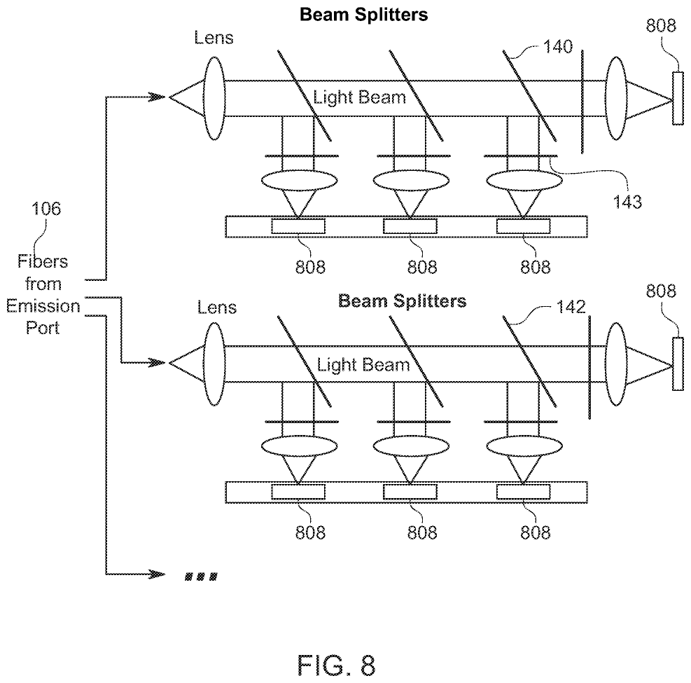

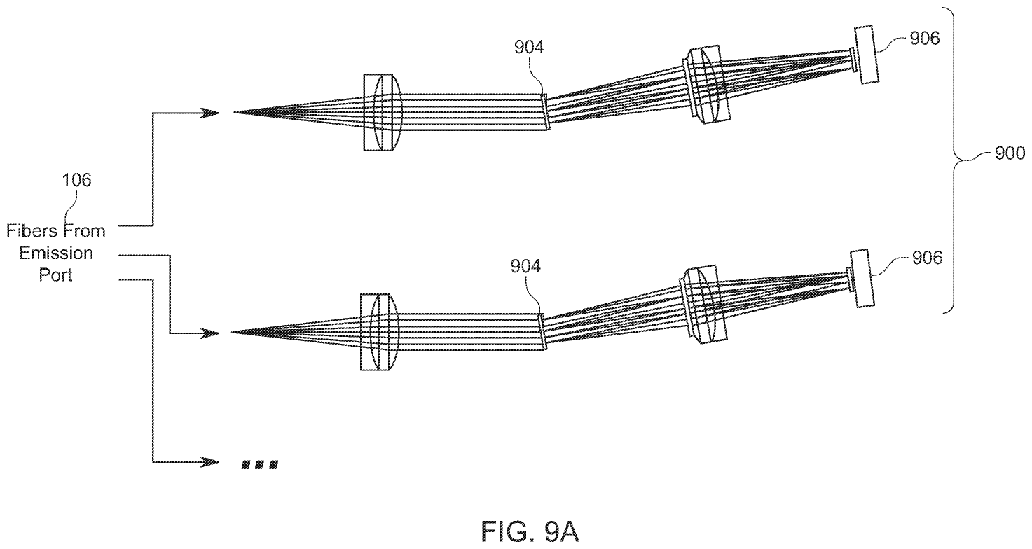

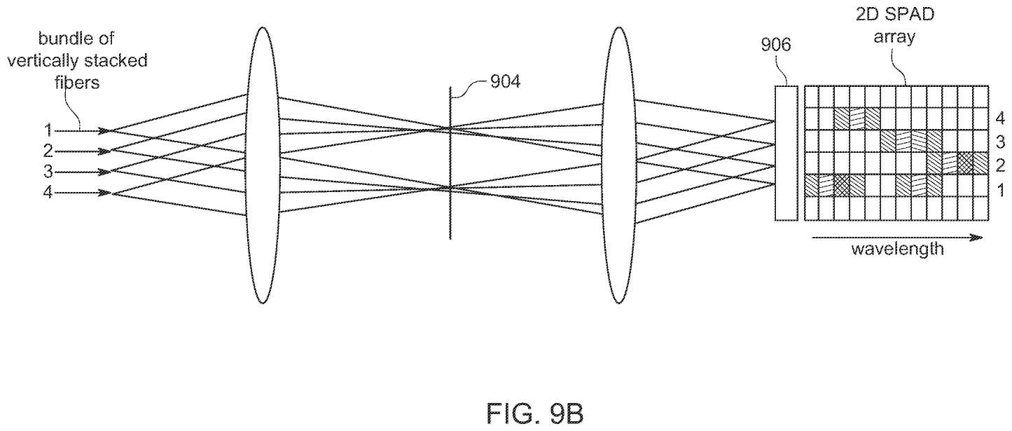

The detector assembly 108 may include any sensor or set of sensors capable of sufficiently detecting the fluorescent light emitted from the multiple spots of the sample. FIGS. 8 and 9 illustrate beneficial examples of detection assemblies. However, additional or alternative light detection components known in the art or later discovered may be included in other embodiments.

FIG. 8 is an example detector assembly 108 including multiple spectral detector modules 140, where each spectral detector module 140 is a bank of sensors, with each sensor 808 preferably being photomultiplier tubes (PMTs). Although only two spectral detector modules 140 are shown here, the ellipsis illustrate that additional detector modules 140 may be included. For example, detector assemblies will typically include as many spectral detector modules 140 as laser sources 122 so that the emission light resulting from each laser source can be independently detected. The number of spectral detector modules 140 may also equal the number of emission fibers. However, in embodiments such as shown in FIG. 6, each fiber group 109 may be associated with a spectral detector module 140, and each fiber group 109 may include multiple emission fibers. A detector module 140 comprising a bank of sensors, where each bank comprises four sensors 808 is shown for illustrative purposes only. Each detector module may include a bank of sensor comprising a number greater than or less than four sensors 808.

As described above, the spectral detector modules 140 receive emission light from the emission port 106 via the emission fibers 117. The illustrated spectral detector modules 140 may include one or more laser light filters (not shown) to filter out excitation light. The laser light filter may be a long pass filter, for example, configured to filter light corresponding to the excitation wavelengths used. Some embodiments may additionally or alternatively include other types of laser light filters, such as band pass filters and/or notch filters. Long pass filters, when included, may be used in such a way that light with higher wavelength than the corresponding excitation laser can pass but light with equal or lower wavelength is blocked. Notch filters, as understood to one of skill in the art, block light within a defined band width (e.g., about 10-20 nm). The illustrated detector modules 140 also include one or more filter and/or dichroic elements 142 for separating and measuring multiple emission bands. One or more sensor filters 143 (e.g., band pass filters and/or other filter types described herein) may additionally or alternatively be positioned in front of each sensor. The illustrated detector modules 140 are each configured to measure four different emission bands and thus provide four different detection channels. Other embodiments may measure fewer or more emission bands and thus have a fewer or greater number of detection channels.

FIG. 9A is an example detector assembly 108 including multiple spectral detector modules 140 in the form of spectrometers 900. As with the detector assembly of FIG. 8, the illustrated detector assembly may include more than two spectrometers 900 and may include as many spectrometers 900 as laser sources. The spectrometer 900 may include a dispersive element 904. The dispersive element 904 is designed to receive an amount of incident light and disperse the incident light into spatially separated wavelengths of light. Dispersive element 904 may include, but not limited to a prism, a grid, or a combination of both. Dispersion elements have been disclosed in, U.S. Pat. No. 7,280,204 to Robinson, et.al. entitled “MULTI-SPECTRAL DETECTOR AND ANALYSIS SYSTEM”, issued on Oct. 9, 2007, and is hereby incorporated by reference in its entirety. The spectrometers 900 may include a detector 906 in the form of one or more single photon avalanche diodes (SPADs), for example. In some embodiments, a plurality of SPADs are arranged in an array, such as a one-dimensional array, a two-dimensional array, or the like. Such embodiments may beneficially enable detection at higher resolutions, lower dark count rate (DCR), and better signal to noise ratio (SNR), especially at the red wavelengths relative to the use of PMT detectors. The speed of the SPAD detector defines the scan speed of confocal descanned detection. The speed of the SPAD detector is related to the dead time of the SPAD pixel (typically 10 ns) and the readout speed of the array (typically 2 MHz). The use of spectrometers allows for a relatively high number of detection channels, essentially enabling measure of the full spectrum rather than less granular emission bands. Via bining of the signal of individual pixel the signal from flourophores can be varied and optimized after data acquisition. The dispersion of the prism or grating can be easily optimized to the pixel size and the spectrum of the fluorophores before image acquisition via exchanging of the grating/prism. Gating of the SPAD array will allow time domain multi-spectral experiments, if fast pulsed lasers (pico second laser pulsed, or fast modulated laser light) is used for fluorescent excitation. SPAD pixel provide photon counting capabilities. The low DCR of the SPAD array simplifies quantitative analysis of the fluorescence signal.

Multiple fibers may be attached to just one spectrometer. FIG. 9B shows a side view of one spectrometer 900 with multiple fibers attached to it. Instead of using a spectrometer 900 for each emission fiber, the emission fibers can be (vertically) stacked in one connector and be connected to only one spectrometer 900. The light of each fiber is projected via collimation optics onto the array detector. The light of each fiber of the bundle is collimated, then a dispersive element generates a spectrum on a one/two-dimensional detector 906. The spectra of the different fibers are spatially (vertically, or horizontally) spaced. In some embodiments, the detector is a two-dimensional SPAD array.

### Frequency Modulation

Although the spots projected onto the sample plane 118 are spatially separated from each other, the spots may be close enough that one excitation light beam can often scatter and reach one or more other spots. This scattered excitation light can add to the fluorescent emission signal of these other spots, adulterating the emission signal.

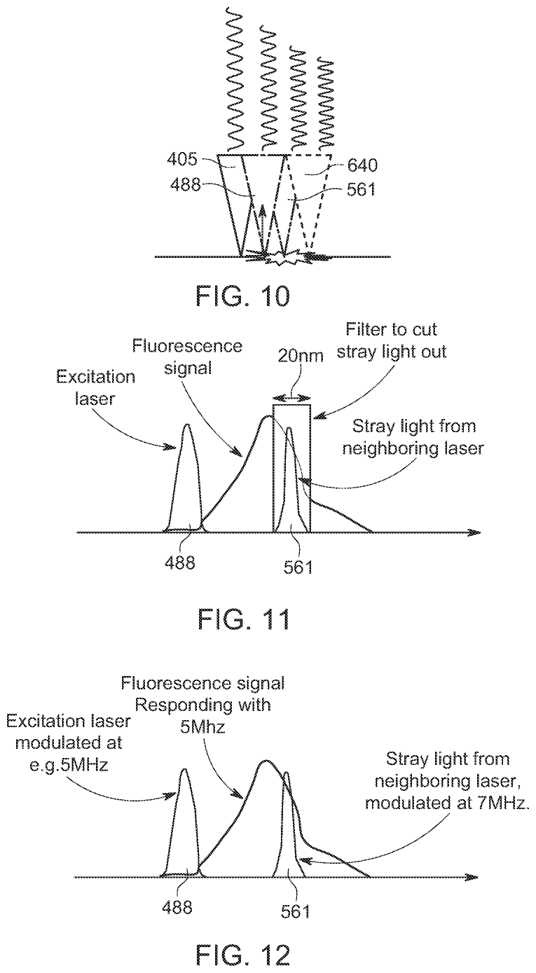

FIG. 10 is a schematic showing potential cross talk between spatially separated excitation spots with different excitation light wavelengths. FIG. 10 shows that light projected onto one spot can scatter and be detected as coming from one or more other spots. Here, 561 nm excitation light is shown as scattering enough to reach the neighboring 488 nm spot. The 561 nm excitation light thus adulterates the emission light resulting from the neighboring spot. The same phenomenon can occur at other spots and/or can be caused by scattering from other excitation light. For simplicity, only the interference to the emission signal from the 488 nm spot, as caused by the scattered 561 nm light, is shown here.

FIG. 11 is a graphical representation showing an optical filtering process that may be utilized to reduce or eliminate cross talk issues such as those illustrated in FIG. 10 by using one or more notch filters to minimize or remove the scattered light. As shown, one option for minimizing or removing the stray, scattered light is to use one or more notch filters that remove any portion of the signal at or close to the wavelength of the stray light. However, the notch filter(s) remove not only the stray light but also a portion of the emission signal. As shown in FIG. 11, for example, the notch filter may remove a band of about 20 nm. Although this substantially removes the scattered, stray light, it also undesirably removes the overlapping portion of the emission signal. Although notch filters are shown here, the same effect (i.e., gaps in the detected spectrum) can result from the use of other types of filters. For example, the example configuration shown in FIG. 8 utilizes a long pass filter in front of the detector modules 140 and band pass filters 143 in front of each individual detector. The band pass filters 143 are selected to exclude stray laser light from neighboring excitation spots, which leaves a gap in the detected spectrum.

FIG. 12 represents another option for addressing the cross talk problem (such as illustrated in FIG. 10) by filtering scattered excitation light using frequency modulation. In such embodiments, each excitation source is modulated at a different frequency. Scattered, stray light from other laser sources can then be filtered based on frequency because it will have a different frequency than the fluorescence signal resulting from the intended laser source. In the example of FIG. 12, the 488 nm laser source is modulated at 5 MHz. The resulting fluorescence emission signal thus also has a frequency of 5 MHz. The 561 nm laser source, on the other hand, is modulated at 7 MHz. The 488 nm fluorescence signal can be filtered to remove the scattered 561 nm light based on the difference in frequency. Such filtering may be accomplished using one or more frequency filtering methods as well known in the art. More of the signal is therefore maintained relative to when notch filters are used.

The illustrated example uses frequencies of 5 MHz and 7 MHz, though other embodiments may use additional or alternative frequencies. The specific frequencies at which the laser sources are modulated may vary, so long as the frequency differences are great enough to enable sufficient filtering. In addition, the frequencies of the laser sources should avoid overlap with the scanning frequency of the scan head 110. For example, if the scan head 110 operates to scan the sample plane 118 at a frequency of 1 Mega sample per second (1 MSPS), the laser source frequencies are preferably set to be greater than 1 MHz.

### Generating a Distribution from Multiplexed Spectral Fluorescence Data

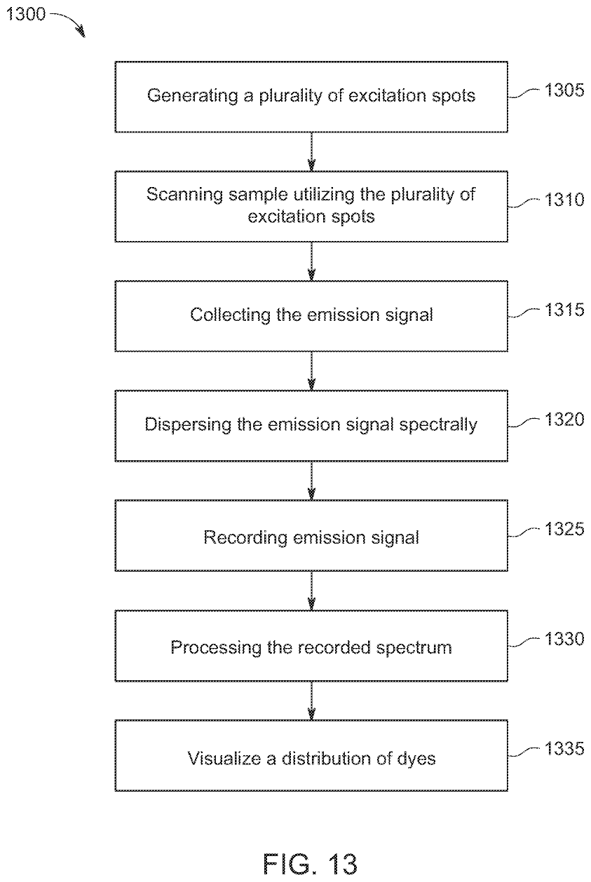

FIG. 13 illustrates an exemplary method 1300 for configuring a confocal microscope system as described earlier in this disclosure for a distribution from multiplexed spectral fluorescence data. At step 1305, the confocal system is configured to generate a plurality of spatially-separated excitation spots using a bundle of single mode fibers. This may be implemented, without limitations, as described in reference to FIGS. 1-12.

At step 1310, the confocal system is configured to raster-scan a sample utilizing the plurality of excitation spots simultaneously Fluorescent emission signal may be generated in each excitation spot. This may be implemented, without limitations, as described in reference to FIGS. 1-12.

At step 1315, the confocal system is configured to collect the emission signal generated from each excitation spot simultaneously by multiple optical fibers. This may be implemented, without limitations, as described in reference to FIGS. 1-12.

At step 1320, the confocal system is configured to spectrally disperse the emission signal from each excitation spot with optical filters or spectrometers. This may be implemented, without limitations, as described in reference to FIGS. 1-12.

At step 1325, the confocal system is configured to record the dispersed emission signal from each excitation spot. The recording may be accomplished from a plurality of photo sensors or a sensor array. This may be implemented, without limitations, as described in reference to FIGS. 1-12.

The recorded spectrum is a superposition of spectra of different dyes in the excitation spot. At step 1330, the confocal system is configured to process the recorded spectrum to unmix the individual spectra of the dyes. This may be implemented, without limitations, as described in reference to FIGS. 1-12.

Each position (pixel) of the raster scan can be assigned intensities of different dyes. At step 1335, the confocal microscope system is configured to visualize a distribution of the dyes for each of the dyes. In an embodiment, the system may be configured to generate an intensity map. In another embodiment, the system is configured to generate an image. The different intensity maps can be overlayed into one image. To do so, the images might need to be shifted laterally, taking the spatial separation of the excitation spots into account.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

What is claimed is:

1. A confocal microscope system for multiplexed spectral fluorescence imaging, comprising:
an excitation light assembly configured to provide excitation light at a plurality of wavelengths;
a scan head optically connected to the excitation light assembly, wherein the excitation light from the excitation light assembly is directed onto a sample plane through an optical assembly, wherein the optical assembly comprises:
a first lens;
at least one reflective surface; and
a second lens;
a plurality of optical excitation fibers, each fiber coupled to the excitation light assembly, and each fiber configured to transmit a separate beam of excitation light from the excitation light assembly to the scan head through one or more ports,
wherein the plurality of optical excitation fibers is configured to transmit the separate beams of excitation light to a plurality of, spatially separated spots on a sample plane simultaneously;
a plurality of emission fibers optically coupled to the scan head by one or more ports, wherein each fiber is configured to receive emission light from the sample plane; and
a detector assembly optically connected to the plurality of emission fibers, wherein the detector assembly receives emission light.

2. The confocal microscope system of claim 1, wherein each excitation fiber of the plurality of excitation fibers transmits excitation light of a different wavelength, each spot thereby providing excitation light at a different wavelength to the sample plane.

3. The confocal microscope system of claim 1, wherein the excitation light assembly comprises a plurality of laser sources, wherein each laser source of the plurality of laser sources is configured to provide excitation light at a different wavelength and coupled to a corresponding excitation fiber, and wherein each excitation fiber corresponds to a separate spot on the sample plane to which the scan head directs the respective wavelength of excitation light.

4. The confocal microscope system of claim 1, wherein the excitation fibers are disposed in an excitation fiber bundle, the excitation fibers of the excitation fiber bundle terminating at an excitation connector configured to define spacing of the excitation fibers relative to each excitation fiber and configured to connect the excitation fiber bundle to a port of the one or more ports, wherein the excitation fibers are equidistantly spaced within the excitation connector, and wherein the corresponding spots transmitted to the sample plane are equidistantly spaced.

5. The confocal microscope system of claim 1, wherein the scan head comprises one or more adjustable mirrors to enable scanning of the plurality of spots of excitation light onto the sample plane, wherein the scan head is configured to scan the plurality of spots of excitation light onto the sample plane according to a two-dimensional raster.

6. The confocal microscope system of claim 1, wherein the excitation light assembly is configured to provide excitation light at a plurality of modulation frequencies, and wherein the excitation light assembly is configured to provide a different wavelength of excitation light for each frequency in the plurality of modulation frequencies.

7. The confocal microscope system of claim 1, wherein each excitation fiber in the plurality of excitation fibers is matched to at least one emission fiber such that each emission fiber receives emission light resulting from the excitation light of a corresponding excitation fiber.

8. The confocal microscope system of claim 7, wherein the emission fibers are disposed in an emission fiber bundle, the emission fibers of the emission fiber bundle terminating at an emission connector configured to define spacing of the emission fibers equidistant to each emission fiber and configured to connect the emission fiber bundle to a port of the one or more port.

9. The confocal microscope system of claim 1, wherein the detector assembly includes a plurality of light detector modules, each detector module in the plurality of light detector modules providing one or more spectral detection channels.

10. The confocal microscope system of claim 9, wherein each detector module in the plurality of light detector modules includes from at least 1 to at least 15 different spectral detection channels, and wherein each detector module is optically connected to a separate emission fiber or to a separate subset of emission fibers.

11. The confocal microscope system of claim 9, wherein each detector module in the plurality of the detector modules is a bank of multiple photomultiplier tubes (PMTs).

12. The confocal microscope system of claim 9, wherein the detector assembly comprises a plurality of spectrometers, wherein the plurality of spectrometers include a detector comprising one or more single photon avalanche diodes (SPADs), optionally arranged in a linear or a two dimensional array.

13. The confocal microscope system of claim 1, wherein the one or more ports comprise a beam splitter configured to separate excitation and emission light, wherein the beam splitter is disposed within the emission port and has a reflectance to transmission ratio (R:T) of about 5:95 to about 20:80, such as about 10:90.

14. The confocal microscope system of claim 1, wherein the one or more ports omit multi-band dichroic elements for separating excitation and emission light.

15. The confocal microscope system of claim 1, wherein the emission fibers are multi-mode fibers and the excitation fibers are single-mode fibers, the emission fibers having larger core diameters than the excitation fibers.

16. The confocal microscope system of claim 1, wherein the one or more ports comprise an excitation port to which the excitation fibers are connected and a separate emission port to which the emission fibers are connected.

17. The confocal microscope system of claim 1, wherein a single port in the one or more ports is configured to direct excitation light from the excitation fibers to the scan head and to direct emission light to the emission fibers, wherein each excitation fiber is joined in a fiber group with one or more corresponding emission fibers, and wherein for at least one fiber group, the excitation fiber is grouped with multiple emission fibers.

18. A modular port for a confocal microscope system, the modular port comprising:
a scan head attachment site where the modular port attaches to a laser scanning confocal microscope scan head;
a fiber bundle attachment site where the modular port attaches to an optical fiber bundle; and
an interior optical assembly that forms an optical path for transmission of excitation light from the optical fiber bundle, when connected, toward the scan head attachment site, or for transmission of emission light from the scan head, when connected, toward the fiber bundle attachment site,
wherein the interior optical assembly includes a beam splitter disposed along the optical path between the scan head attachment site and the fiber bundle attachment site.

19. The modular port of claim 18, further comprising a secondary port attachment site for connecting a secondary port to the modular port, the secondary port attachment site being substantially aligned with the beam splitter such that:
the beam splitter can reflect light received from a connected scan head into the secondary port, and/or
the beam splitter can reflect light received from the secondary port toward a connected scan head,
wherein the modular port is configured as an emission port for passing emission light from a connected scan head toward the fiber bundle attachment site, and wherein the beam splitter has a reflectance to transmission ratio (R:T) with greater transmission than reflectance.

20. The modular port of claim 18, wherein the modular port is configured as an excitation port for passing excitation light from a connected optical fiber bundle toward the scan head attachment site, and wherein the beam splitter has a reflectance to transmission ratio (R:T) with greater reflection than transmission.
